(19) United States
(12) Patent Application Publication
(10) Pub. No.: US 2007/0214798 A1
(43) Pub. Date: Sep. 20, 2007

(54) Process For Producing Electrical Power

(75) Inventor: Ludo K. Frevel, Midland, MI (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: Dow Corning Corporation, Midland, MI (US)

(21) Appl. No.: 11/578,924

(22) PCT Filed: Apr. 21, 2005
(86) PCT No.: PCT/US05/13782

§ 371 Date: Oct. 19, 2006

Related U.S. Application Data
(60) Provisional application No. 60/564,818, filed on Apr. 23, 2004.

(51) Int. Cl. F02C 3/30

(52) U.S. Cl. 60/775

(57) ABSTRACT

A process for producing electrical power including the steps of: a) combusting a stoichiometric amount of a reactant in air in the presence of atomized water to obtain a gaseous mixture having a terminal temperature less than a maximum operating temperature of a gas turbine, b) feeding the gaseous mixture to the gas turbine to generate electrical power wherein a gas turbine exhaust exits the gas turbine, c) feeding the gas turbine exhaust stream into a boiler to generate superheated steam and a boiler exhaust stream, d) feeding the superheated steam to a steam turbine to generate electrical power, e) feeding the boiler exhaust stream to a heat exchanger condensing water, and f) circulating at least a portion of the condensed water to the combustion step a).

### RELATED APPLICATION

This application claims priority of U.S. Provisional Patent Application Ser. No. 60/564,818 filed Apr. 23, 2004, which is incorporated herein by reference.

### BACKGROUND OF THE INVENTION

1. Field of the Invention

The invention relates to a process for producing electrical power, and more particularly, to a process for producing electrical power by combusting a stoichiometric amount of a reactant in the presence of atomized water.

2. Description of the Related Art

Modern power plants typically use a gas turbine to produce electrical power from a combusted fuel mixture. Typically the gas turbine includes a compressor section for pressurizing air which is mixed with a fuel and burned in one or more combustors.

Typical combustors do not combust the fuel mixture and air in a stoichiometric ratio, as such combustion of an air fuel mixture results in very high temperatures within the combustor. The high temperatures can damage the turbine section of a gas turbine, as well as lead to increased amounts of nitrogen oxides produced by the combustion process.

Attempts at limiting the temperature produced in a combustor include reacting air fuel mixtures in ratios considerably less than stoichiometric using excess amounts of air to cool the combustion gas to temperatures suitable for use in the turbine section. However, by introducing an excess amount of air into the combustion process, a large amount of energy or work is required by a compressor to compress the additional air, resulting in an over all loss of efficiency of producing electrical power.

There is, therefore, a need in the art for a process for producing electrical power that combusts an air fuel mixture in an approximate stoichiometric ratio and limits the temperature of the combustion gases for use in a gas turbine, resulting in an overall increase in capacity of an electrical power plant.

### SUMMARY OF THE INVENTION

Accordingly, it is an object of the present invention to provide a process for producing electrical power by combusting a stoichiometric amount of a reactant and air; thereby, increasing an overall efficiency of a power plant.

These and other objects of the present invention are accomplished by a process for producing electrical power including the steps of: a) combusting a stoichiometric amount of a reactant and air in the presence of atomized water to obtain a gaseous mixture having a terminal temperature less than a maximum operating temperature of a gas turbine, b) feeding the gaseous mixture to the gas turbine to generate electrical power wherein a gas turbine exhaust stream exits the gas turbine, c) feeding the gas turbine exhaust stream into a boiler to generate superheated steam and a boiler exhaust stream, d) feeding the superheated steam to a steam turbine to generate electrical power, e) feeding the boiler exhaust stream to a heat exchanger condensing water, and f) circulating at least a portion of the condensed water to the combustion step a).

### BRIEF DESCRIPTION OF THE DRAWINGS

FIG. 1 is a schematic diagram of a first embodiment of the process using methane as a reactant for producing electrical power of the present invention;

FIG. 2 is a schematic diagram of a second embodiment of the process using propane as a reactant for producing electrical power of the present invention;

FIG. 3 is a schematic diagram of a third embodiment of the process using hydrogen as a reactant for producing electrical power of the present invention;

FIG. 4 is a schematic diagram of an alternative first embodiment of the process using methane as a reactant for producing electrical power of the present invention.

### DESCRIPTION OF THE PREFERRED EMBODIMENTS

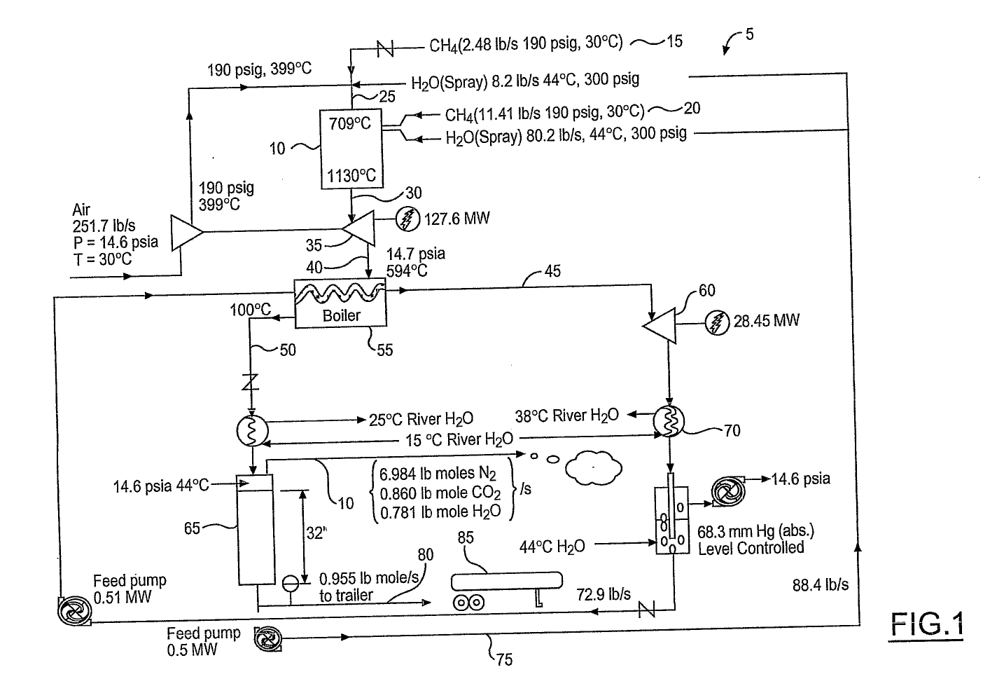

Referring to FIG. 1, there is shown a schematic representation of a process 5 for producing electrical power of a first embodiment having methane as a reactant. In a first combustion step 10 of the process 5 for producing electrical power of the present invention, a stoichiometric amount of methane and compressed air is combusted in the presence of atomized water to obtain a gaseous mixture having a terminal temperature less than a maximum operating temperature of a gas turbine. Modern day gas turbines typically have an upper operating range of from 1150 to 1510 degrees Celsius dependant upon the materials used to form the gas turbine. The stoichiometric combustion of methane includes the reaction of one mole of methane with two moles of oxygen and eight moles of nitrogen yielding one mole of carbon dioxide, two moles of water and eight moles of nitrogen with a flame temperature of about 1918 degrees Celsius, well above the range of gas turbines outlined above. To regulate this temperature to an acceptable range, the combustion step includes providing atomized water to the combustion mixture resulting in a flame temperature less than the maximum operating temperature of the gas turbine.

In a preferred aspect of the present invention, the atomized water has an initial droplet size in the range of from 30 microns to 200 microns; thereby, preventing damage to blades of a gas turbine by droplets having a large size. The atomized water regulates the temperature of the gaseous mixture by absorbing heat when it is vaporized from a liquid to a gaseous state. To assure that the liquid droplets of water are flash-evaporated, the droplets preferably contact a hot metallic surface. For example, metal screens or similar structures may be utilized to increase the surface or contact area for the liquid droplets; thereby regulating the temperature of the combustion stream.

The combustion step of the process of the present invention preferably comprises two (or more) separate combustion steps 15, 20. A first step 15 includes combusting a portion of the reactant (total reactant-x) with the total stoichiometric amount of air, in the presence of an amount of atomized water (y) to produce a first combustion stream 25 which has a temperature that exceeds an auto-ignition temperature of the reactant. The second combustion step 20 comprises combusting the remaining portion of the reactant (x) with the first combustion stream 25, again in the presence of atomized water (total water-y) to obtain a gaseous mixture 30 that has a terminal temperature less than the maximum operating temperature of the gas turbine outlined above.

Again referring to FIG. 1, there is shown a schematic representation of a 140 megawatt power plant utilizing methane as the reactant. A typical present day 140 megawatt power plant burns 13.89 pounds per second of methane with 790 pounds per second of compressed air to regulate the temperature of the combustion mixture. This amount of air greatly exceeds a stoichiometric amount, as used by the present invention. The first embodiment, disclosed in FIG. 1, burns 13.89 pounds per second of methane in a stoichiometric ratio with 251.7 pounds per second of air.

As described above, the combustion step includes two separate stages or combustion steps 15, 20. In a first combustion step 15, 2.48 pounds per second of methane (total methane-x where 13.89>x>0) is combusted with 251.7 pounds per second of air in the presence of 8.2 pounds per second of atomized water (y where 88.4>y>0) yielding a first combustion stream 25 having a temperature of 709 degrees Celsius. The first combustion stream 25 having a temperature of 709 degrees Celsius is above the auto-ignition temperature of methane (705 degrees Celsius), thereby yielding a continuous self-sustaining combustion. The first combustion stream 25 is then combusted with 11.41 pounds per second methane (x) and 80.2 pounds per second atomized water (total water-y) yielding a gaseous mixture 30 having a terminal temperature of 1130 degrees Celsius at a pressure of 180 PSI. The gaseous mixture 30 is then fed to a gas turbine 35 where the gaseous mixture 30 is dropped to a pressure of 14.7 PSI including a temperature drop to 594 degrees Celsius; thereby, generating 127.6 megawatts of electric power. The gas turbine exhaust stream 40 exits at a temperature of 594 degrees Celsius and is fed to a boiler 55 to generate superheated steam 45 and a boiler exhaust stream 50. The superheated steam 45 has a temperature of approximately 530 degrees Celsius, and a pressure of approximately 1250 PSI. The superheated steam 45 is fed to a steam turbine 60 to generate 28.45 megawatts of electrical power. The steam 45 is then condensed at 70 and recycled to the boiler 55. The boiler exhaust stream 50 is fed to a heat exchanger 65 for condensing water. As can be seen from FIG. 1, a first portion 75 of the condensed water equaling 88.4 pounds per second is recycled to the combustion step 10 with the remaining portion of water 80 sent to a storage container 85 for use in other applications. The top stream 90 of the heat exchanger 65 emits to the atmosphere 6.984 pound moles of nitrogen per second, 0.86 pound moles carbon dioxide per second and 0.781 pound moles of water per second.

The overall amount of atomized water necessary for maintaining the gaseous mixture 30 of the combustion step in the range of 1130 degrees Celsius is computed by calculating the overall heat of combustion produced for a given flow rate of reactant and calculating the amount of water necessary to absorb sufficient heat by vaporization to maintain the temperature in the range of 1130 degrees Celsius. The amount of water used in the first combustion step 15 is calculated by determining an amount of water necessary to produce a first combustion stream 25 having a temperature above the auto ignition temperature of the reactant.

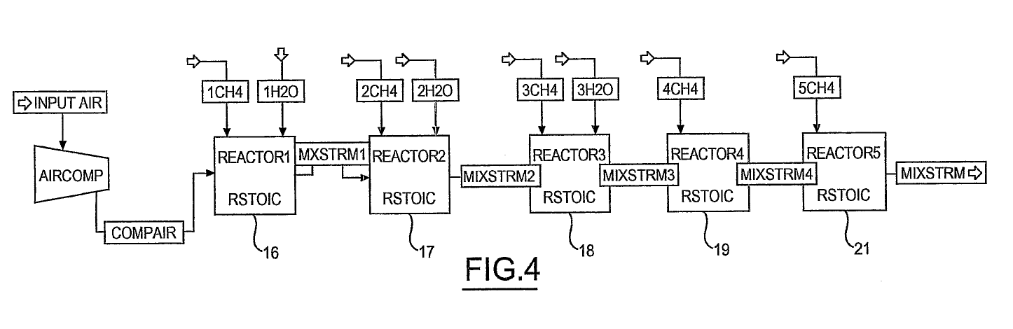

Referring to FIG. 4, there is shown an alternative embodiment of the first embodiment for producing electrical power having methane as the reactant. In the depicted alternative embodiment, the methane is added in a step-wise manner with five separate combustion steps 16, 17, 18, 19, 21, as opposed to the two combustion steps 15, 20 of the first embodiment. While 5 combustion steps are described in the alternative embodiment of FIG. 4, it should be realized that other numbers of step-wise combustion steps may be used by the present invention.

The rate of combustion of CH₄ is 2-3 orders of magnitude greater than the rate of evaporation of water droplets added to control the flame temperature. As a consequence, the flame temperature at the instant of ignition approaches 1900 degrees Celsius and results in the generation of an excessive concentration of NO. To limit the flame temperature to 1300 degrees Celsius a stepwise addition of CH₄ may be utilized.

For a 5-step addition of CH₄, as shown in FIG. 4 and detailed in Table 1 appended at the end of the specification, the first combustion step 16 includes combusting 2.5 pounds per second CH₄ and 256.7 pounds per second air. The addition of 6.2 pounds per second liquid water reduces the top temperature of 1300 degrees Celsius to 710 degrees Celsius. The second combustion step 17 includes combusting the product stream of the first combustion step with 2.5 pounds per second CH₄, and 31.0 pounds per second of liquid water to reduce the peak temperature to 709 degrees Celsius. The third combustion step 18 includes combusting the product stream of the second combustion step with 2.5 pounds per second CH₄, and 29.4 pounds per second of liquid water to reduce the peak temperature to 721 degrees Celsius. The fourth combustion step 19 includes combusting the product stream of the third combustion step with 1.5 pounds per second CH₄ and no liquid water to produce a peak temperature of 870 degrees Celsius. The fifth combustion step 21 includes combusting 4.9 pounds per second CH₄ and no liquid water to produce a fifth product stream having a peak temperature of 1300 degrees Celsius.

The fifth product stream corresponds to the gaseous mixture 30 of the first embodiment. At this point, the process of the first and alternative embodiments is the same. The fifth product stream, which is the same as the gaseous mixture 30 is fed to a gas turbine 35 to generate 133.3 megawatts of electric power. Table 2, appended at the end of the specification, details the flow rates, temperatures, and pressures of the alternative embodiment corresponding to the various components of the process shown in FIG. 1. The gas turbine exhaust stream 40 from the gas turbine is fed to a boiler 55 to generate superheated steam 45 and a boiler exhaust stream 50. The superheated steam 45 is fed to a steam turbine 60 to generate 31.0 megawatts of electrical power. From the combined cycles, a total of 161.39 megawatts of power are generated, a gain of 15 percent over a conventional 140 megawatt plant.

Additionally, 38.1 pounds per second CO₂ is produced by both a conventional plant and the alternative embodiment. However, 13 percent more CO₂ is generated per megawatt by the conventional power plant. As shown in FIG. 4, the terminal concentration of O₂ in the fifth combustion is very small, 0.5 pounds per second. This results in a very small concentration of NO released to the atmosphere.

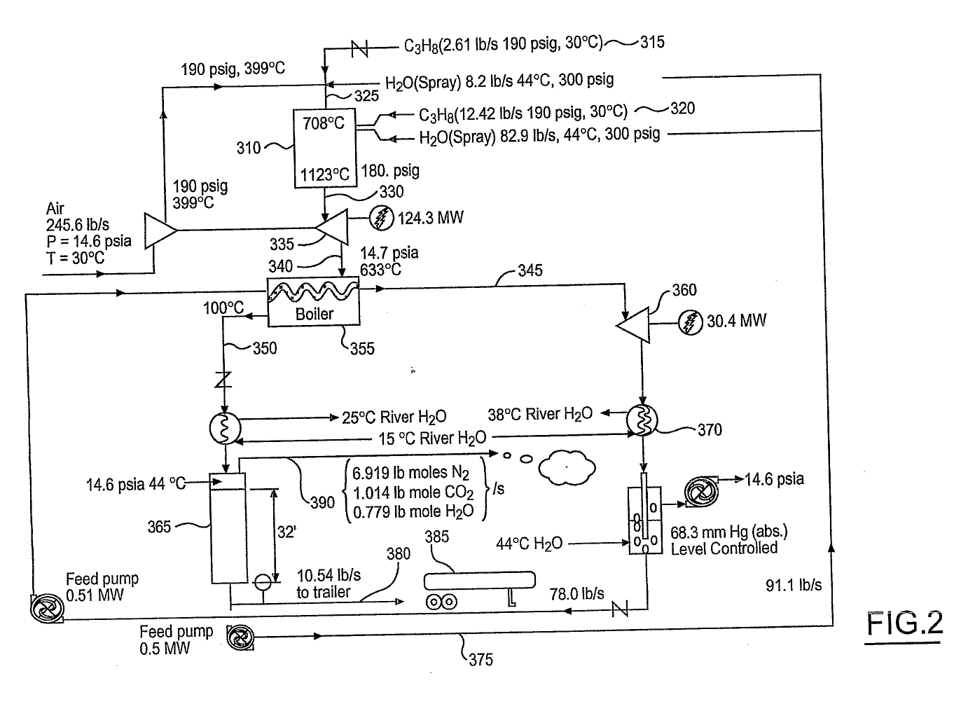

Referring to FIG. 2, there is shown a second embodiment 305 of the process for producing electrical power of the present invention. The second embodiment 305 utilizes propane as a reactant. As with the first embodiment, the propane is combusted in a first step 310 with air in a stoichiometric amount in the presence of atomized water to obtain a gaseous mixture having a terminal temperature less than the maximum operating temperature of the gas turbine. As can be seen in FIG. 2, the combustion step 310 preferably comprises two steps 315, 320. In the first step 315, 2.61 pounds per second of propane is combusted with 245.6 pounds per second air in the presence of 8.2 pounds per second atomized water, yielding a first combustion stream 325 having a temperature of 708 degrees Celsius. In a second combustion step 320, 12.42 pounds per second of propane is combined with the first combustion stream 325 and 82.9 pounds per second of atomized water yielding a gaseous mixture 330 having a temperature of approximately 1123 degree Celsius at 180 PSI. The gaseous mixture 330 is fed to a gas turbine 335 and is subjected to a pressure drop to 14.7 PSI with a temperature of the turbine exhaust 340 of approximately 633 degrees Celsius. The gas turbine generates 124.3 megawatts of power. The 633 degree Celsius turbine exhaust stream 340 is fed to a boiler 355 for generating superheated steam 345 at a temperature of 530 degrees Celsius and a pressure of 1250 PSI. The superheated steam 345 is then fed to a steam turbine 360 generating 30.4 megawatts of power. The boiler exhaust stream 350 is fed to a heat exchanger 365 for condensing water. As with the first embodiment, a first portion 375 of the condensed water equaling 91.1 pounds per second is recycled to the combustion step 310 with the remaining portion 380 of 10.54 pounds per second of water being sent to a storage container 385. The top stream 390 of the heat exchanger 365 comprises 6.91 pound moles of nitrogen per second, 1.014 pound moles of carbon dioxide per second and 0.779 pound moles of water per second that is released into the atmosphere. As with the previously described first embodiment, the second embodiment results in an increased capacity due to the significantly smaller amount of compressed air utilized as compared to common present day power plants. A further advantage of the process includes a nitrogen oxide emission of less that two parts per million by volume.

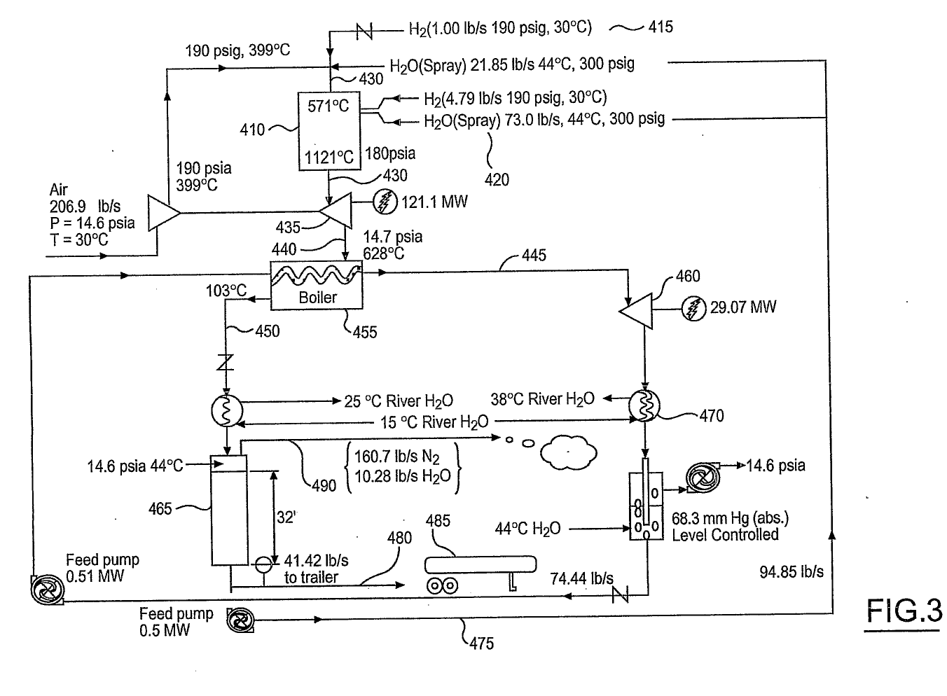

Referring to FIG. 3, there is shown a third embodiment 405 of the present invention in which hydrogen is utilized as the reactant. As with the previously described embodiments, the combustion step 410 includes two steps 415, 420. In the first step 415 one pound per second of hydrogen is combusted with 206.9 pounds per second of air in the presence of 21.85 pounds per second of atomized water, yielding a first combustion stream 425 having a temperature of 571 degrees Celsius. In the second combustion step 420, 4.79 pounds per second of hydrogen is combined with the first combustion stream 425 and combusted in the presence of 73.0 pounds per second of atomized water, yielding a gaseous mixture 430 having a terminal temperature of 1121 degrees Celsius. The gaseous mixture 430 is fed to a gas turbine 435 and is subjected to a pressure drop to 14.7 PSI; thereby generating 121.1 megawatts of power. The gas turbine exhaust stream 440 at 628 degrees Celsius is fed to a boiler 455 generating superheated steam 445 at a temperature of 530 degrees Celsius and 1250 PSI. The superheated steam 445 is fed to a steam turbine 460; thereby generating 29.07 megawatts of power. The boiler exhaust stream 450 is fed to a heat exchanger 465 for condensing water. The water condensed includes a first portion 475 equaling 94.85 pounds per second which is recycled to the combustion step 410 and a second portion 480 equaling 41.42 pounds per second which is sent to a storage container 485. The top stream 490 of the heat exchanger 465 emits 160.7 pounds per second of nitrogen gas and 10.28 pounds per second of water vapor to the atmosphere. As with the previously described embodiments, the third embodiment 405 limits the amount of compressed air utilized and thereby the amount of energy used for the compression, resulting in an increased capacity for producing electrical power. No CO₂ is generated.

Comparing the cost of generating electrical power, one notes that the fuel cost is the same for any plant at any particular site. However, the capital costs are markedly lower for the stoichiometric plant utilizing the process of the present invention. The size and flow capacity of compressors and turbines is significantly reduced with a corresponding reduction in the amount of power needed to operate the compressors. For example, if the cost of a 500 megawatt gas turbine for a conventional power plant is $100,000,000, then the cost of the gas turbine for a 500 megawatt stoichiometric power plant is in the range of only $33,000,000. As a result, significant cost savings are achieved by the process of the present invention.

The invention has been described in an illustrative manner, and it is to be understood that the terminology that has been used is intended to be in a nature of words of description rather than limitation.

Many modifications and variations of the present invention are possible in light of the above teachings. It is therefore, to be understood that within the scope of the appended claims, the invention may be practiced other that as specifically described.

TABLE 1

| | | COMPAIR | | | MXSTRM1 | | | MIXSTRM2 |
|---|---|---|---|---|---|---|---|---|
| | INPUTAIR | REACTOR1 | 1CH4 | 1H2O | REACTOR2 | 2CH4 | 2H2O | REACTOR3 |
| | AIRCOMP | AIRCOMP | REACTOR1 | REACTOR1 | REACTOR1 | REACTOR2 | REACTOR2 | REACTOR2 |
| | VAPOR | VAPOR | VAPOR | LIQUID | VAPOR | VAPOR | LIQUID | VAPOR |
| Vapor Frac | 1.00 | 1.00 | 1.00 | 0.00 | 1.00 | 1.00 | 0.00 | 1.00 |
| Liquid Frac | 0.00 | 0.00 | 0.00 | 1.00 | 0.00 | 0.00 | 1.00 | 0.00 |
| Solid Frac | 0.00 | 0.00 | 0.00 | 0.00 | 0.00 | 0.00 | 0.00 | 0.00 |
| Mass Flow lb/sec | | | | | | | | |
| NITRO-01 (N₂) | 195.8 | 195.8 | 0.0 | 0.0 | 195.8 | 0.0 | 0.0 | 195.8 |
| CARBO-01 (CO₂) | 0.0 | 0.0 | 0.0 | 0.0 | 6.8 | 0.0 | 0.0 | 13.6 |
| WATER | 0.0 | 0.0 | 0.0 | 6.2 | 11.7 | 0.0 | 31.0 | 48.3 |
| METHA-01 (CH₄) | 0.0 | 0.0 | 2.5 | 0.0 | 0.0 | 2.5 | 0.0 | 0.0 |
| OXYGE-01 (O₂) | 55.9 | 55.9 | 0.0 | 0.0 | 46.0 | 0.0 | 0.0 | 36.1 |
| PROPA-01 (C₃H₈) | 0.0 | 0.0 | 0.0 | 0.0 | 0.0 | 0.0 | 0.0 | 0.0 |
| Total Flow | 251.7 | 251.7 | 2.5 | 6.2 | 260.3 | 2.5 | 31.0 | 293.8 |
| (lb/sec) | | | | | | | | |
| Temperature C. | 15 | 371 | 30 | 30 | 710 | 30 | 30 | 709 |
| Pressure atm | 0.98 | 13.93 | 13.93 | 13.93 | 13.93 | 13.93 | 13.93 | 13.93 |
| Pressure (psi) | 14.4 | 204.8 | 204.8 | 204.8 | 204.8 | 204.8 | 204.8 | 204.8 |

| | | | MIXSTRM3 | | MIXSTRM4 | | |
|---|---|---|---|---|---|---|---|
| | 3CH4 | 3H2O | REACTOR4 | 4CH4 | REACTOR5 | 5CH4 | MIXSTRM5 |
| | REACTOR3 | REACTOR3 | REACTOR3 | REACTOR4 | REACTOR4 | REACTOR5 | REACTOR5 |
| | VAPOR | LIQUID | VAPOR | VAPOR | VAPOR | VAPOR | VAPOR |
| Vapor Frac | 1.00 | 0.00 | 1.00 | 1.00 | 1.00 | 1.00 | 1.00 |
| Liquid Frac | 0.00 | 1.00 | 0.00 | 0.00 | 0.00 | 0.00 | 0.00 |
| Solid Frac | 0.00 | 0.00 | 0.00 | 0.00 | 0.00 | 0.00 | 0.00 |
| Mass Flow lb/sec | | | | | | | |
| NITRO-01 (N₂) | 0.0 | 0.0 | 195.8 | 0.0 | 195.8 | 0.0 | 195.8 |
| CARBO-01 (CO₂) | 0.0 | 0.0 | 20.4 | 0.0 | 24.6 | 0.0 | 38.1 |
| WATER | 0.0 | 29.4 | 83.3 | 0.0 | 86.7 | 0.0 | 97.7 |
| METHA-01 (CH₄) | 2.5 | 0.0 | 0.0 | 1.5 | 0.0 | 4.9 | 0.0 |
| OXYGE-01 (O₂) | 0.0 | 0.0 | 26.2 | 0.0 | 20.2 | 0.0 | 0.5 |
| PROPA-01 (C₃H₈) | 0.0 | 0.0 | 0.0 | 0.0 | 0.0 | 0.0 | 0.0 |
| Total Flow | 2.5 | 29.4 | 325.7 | 1.5 | 327.2 | 4.9 | 332.1 |
| (lb/sec) | | | | | | | |
| Temperature C. | 30 | 30 | 721 | 30 | 870 | 30 | 1300 |
| Pressure atm | 13.93 | 13.93 | 13.93 | 13.93 | 13.93 | 13.93 | 13.93 |
| Pressure (psi) | 204.8 | 204.8 | 204.8 | 204.8 | 204.8 | 204.8 | 204.8 |

TABLE 2

| | (30) | (40) | (50) | (45) | | |
|---|---|---|---|---|---|---|
| | PRODUCT | PRODUCT2 | PRODUCT3 | HOTSTEAM | (80) | (90) |
| | TURBINE | BOILER | COOLER | TURBINE2 | CONDH2O | VENTGAS |
| | REACTOR | TURBINE | BOILER | BOILER | COOLER | COOLER |
| | VAPOR | VAPOR | VAPOR | VAPOR | LIQUID | VAPOR |
| Vapor Frac | 1.00 | 1.00 | 1.00 | 1.00 | 0.00 | 1.00 |
| Liquid Frac | 0.00 | 0.00 | 0.00 | 0.00 | 1.00 | 0.00 |
| Solid Frac | 0.00 | 0.00 | 0.00 | 0.00 | 0.00 | 0.00 |
| Mass Flow lb/sec. | | | | | | |
| NITRO-01 (N₂) | 195.8 | 195.8 | 195.8 | 0.0 | 0.1 | 195.7 |
| CARBO-01 (CO₂) | 38.1 | 38.1 | 38.1 | 0.0 | 0.2 | 37.9 |
| WATER | 97.7 | 97.7 | 97.7 | 94.7 | 83.7 | 14.1 |
| METHA-01 (CH₄) | 0.0 | 0.0 | 0.0 | 0.0 | 0.0 | 0.0 |
| OXYGE-01 (O₂) | 0.5 | 0.5 | 0.5 | 0.0 | 0.0 | 0.5 |
| PROPA-01 (C₃H₈) | 0.0 | 0.0 | 0.0 | 0.0 | 0.0 | 0.0 |
| Total Flow | 332.1 | 332.1 | 332.1 | 94.7 | 84.0 | 248.2 |
| (lb/sec) | | | | | | |
| Temperature C. | 1300 | 747 | 132 | 370 | 44 | 44 |
| Pressure atm | 13.93 | 1.01 | 0.99 | 86.06 | 0.99 | 0.99 |
| Pressure (psi) | 204.8 | 14.8 | 14.6 | 1265.0 | 14.6 | 14.6 |

What is claimed is:

1. A process for producing electrical power comprising the steps of:
a) combusting a stoichiometric amount of a reactant and air in the presence of atomized water to obtain a gaseous mixture having a terminal temperature less than a maximum operating temperature of a gas turbine;
b) feeding the gaseous mixture to the gas turbine to generate electrical power wherein a gas turbine exhaust stream exits the gas turbine;
c) feeding the gas turbine exhaust stream into a boiler to generate superheated steam and a boiler exhaust stream;
d) feeding the superheated steam to a steam turbine to generate electrical power;
e) feeding the boiler exhaust stream to a heat exchanger condensing water.

2. The process for producing electrical power of claim 1 including a step f) following step e) including recirculating at least a portion of the condensed water to the combustion step a).

3. The process for producing electrical power of claim 1 wherein the combustion step a) comprises two or more combustion steps wherein a first combustion step comprises combusting a portion of the reactant with air in the presence of an amount of atomized water producing a first combustion stream having a temperature exceeding an auto ignition temperature of the reactant, and wherein a second combustion step comprises combusting the remaining portion of the reactant with the first combustion stream in the presence of atomized water to obtain a gaseous mixture having a terminal temperature less than a maximum operating temperature of the gas turbine.

4. The process for producing electrical power of claim 3 wherein the reactant comprises methane.

5. The process for producing electrical power of claim 4 wherein 13.89 pounds per second of methane is combusted with 251.7 pounds per second compressed air in the presence of 88.4 pounds per second of atomized water obtaining a gaseous mixture of 196 pounds per second nitrogen, 38.2 pounds per second carbon dioxide, and 119.5 pound per second of steam at a terminal temperature of about 1130 degrees Celsius.

6. The process for producing electrical power of claim 5 wherein in the first combustion step 13.89-x pounds per second methane is combusted with 251.7 pounds per second compressed air in the presence of y pounds per second of atomized water producing the first combustion stream to attain an auto ignition temperature of about 704 degrees Celsius, wherein 13.89>x>0 and 88.4>y>0.

7. The process for producing electrical power of claim 6 wherein in the second combustion step x pounds per second of methane is combusted with the first combustion stream in the presence of 88.4-y pounds per second of atomized water producing the gaseous mixture having a terminal temperature of about 1130 degrees Celsius.

8. The process for producing electrical power of claim 7 wherein x equals 2.48 pounds per second of methane and y equals 8.2 pounds per second atomized water.

9. The process for producing electrical power of claim 8 wherein the gaseous mixture is fed to the gas turbine generating 127.6 megawatts of electrical power and the gas turbine exhaust stream has a temperature of about 594 degrees Celsius.

10. The process for producing electrical power of claim 8 wherein the superheated steam is feed to the steam turbine generating 28.45 megawatts of power.

11. The process for producing electrical power of claim 8 wherein the heat exchanger condenses 105.6 pounds per second of water.

12. The process for producing electrical power of claim 11 wherein 88.4 pounds per second of water is recycled to the combustion step and 17.19 pounds per second of water is transferred to a storage container.

13. The process for producing electrical power of claim 8 wherein gas vented from the heat exchanger comprises 6.984 pound moles per second of nitrogen, 0.860 pound moles of carbon dioxide, and 0.781 pound moles of water.

14. The process for producing electrical power of claim 3 wherein the reactant comprises propane.

15. The process for producing electrical power of claim 14 wherein 15.03 pounds per second of propane is combusted with 245.6 pounds per second compressed air in the presence of 91.1 pounds per second of atomized water obtaining a gaseous mixture of 193.8 pounds per second nitrogen, 44.6 pounds per second carbon dioxide, and 113 pounds per second of steam at a terminal temperature of about 1130 degrees Celsius.

16. The process for producing electrical power of claim 15 wherein in the first combustion step 15.03-x pounds per second propane is combusted with 245.6 pounds per second compressed air in the presence of y pounds per second of atomized water producing the first combustion stream to attain an auto ignition temperature of about 708 degrees Celsius, wherein 15.03>x>0 and 91.1>y>0.

17. The process for producing electrical power of claim 16 wherein in the second combustion step x pounds per second of propane is combusted with the first combustion stream in the presence of 91.1-y pounds per second of atomized water producing the gaseous mixture having a terminal temperature of about 1130 degrees Celsius.

18. The process for producing electrical power of claim 17 wherein x equals 2.51 pounds per second of propane and y equals 8.2 pounds per second atomized water.

19. The process for producing electrical power of claim 18 wherein the gaseous mixture is fed to the gas turbine generating 124.9 megawatts of electrical power and the gas turbine exhaust stream has a temperature of about 633 degrees Celsius.

20. The process for producing electrical power of claim 18 wherein the superheated steam is fed to the steam turbine generating 30.4 megawatts of power.

21. The process for producing electrical power of claim 18 wherein the heat exchanger condenses 101.62 pounds per second of water.

22. The process for producing electrical power of claim 21 wherein 91.1 pounds per second of water is recycled to the combustion step and 10.54 pounds per second of water is transferred to a storage container.

23. The process for producing electrical power of claim 18 wherein gas vented from the heat exchanger comprises 6.919 pound moles per second of nitrogen, 1.014 pound moles of carbon dioxide, and 0.779 pound moles of water.

24. The process for producing electrical power of claim 3 wherein the reactant comprises hydrogen.

25. The process for producing electrical power of claim 24 wherein 5.79 pounds per second of hydrogen is combusted with 206.9 pounds per second compressed air in the presence of 94.85 pounds per second of atomized water obtaining a gaseous mixture of 160.7 pounds per second nitrogen, and 146.8 pounds per second of steam at a terminal temperature of about 1130 degrees Celsius.

26. The process for producing electrical power of claim 25 wherein in the first combustion step 5.79-x pounds per second hydrogen is combusted with 206.9 pounds per second compressed air in the presence of y pounds per second of atomized water producing the first combustion stream to attain an auto ignition temperature of about 571 degrees Celsius, wherein 5.79>x>0 and 94.85>y>0.

27. The process for producing electrical power of claim 26 wherein in the second combustion step x pounds per second of hydrogen is combusted with the first combustion stream in the presence of 94.85-y pounds per second of atomized water producing the gaseous mixture having a terminal temperature of about 1130 degrees Celsius.

28. The process for producing electrical power of claim 27 wherein x equals 1.001 pounds per second of hydrogen and y equals 21.85 pounds per second atomized water.

29. The process for producing electrical power of claim 28 wherein the gaseous mixture is fed to the gas turbine generating 121.13 megawatts of electrical power and the gas turbine exhaust stream has a temperature of about 628 degrees Celsius.

30. The process for producing electrical power of claim 28 wherein the superheated steam is fed to the steam turbine generating 29.07 megawatts of power.

31. The process for producing electrical power of claim 28 wherein the heat exchanger condenses 136.27 pounds per second of water.

32. The process for producing electrical power of claim 31 wherein 94.85 pounds per second of water is recycled to the combustion step and 41.42 pounds per second of water is transferred to a storage container.

33. The process for producing electrical power of claim 28 wherein gas vented from the heat exchanger comprises 160.7 pounds per second of nitrogen, and 10.28 pounds per second of water.

34. The process for producing electrical power of claim 1 wherein the combustion step a) comprises a plurality of combustion steps including combusting the reactant with air in the presence of atomized water to obtain a gaseous mixture having a terminal temperature less than a maximum operating temperature of the gas turbine, and wherein a remaining amount of oxygen following the plurality of combustion steps is reduced.

35. The process for producing electrical power of claim 34 wherein the reactant comprises methane.

36. The process for producing electrical power of claim 35 wherein 13.9 pounds per second of methane is combusted with 251.7 pounds per second compressed air in the presence of 66.6 pounds per second of atomized water obtaining a gaseous mixture of 195.8 pounds per second nitrogen, 38.1 pounds per second carbon dioxide, and 97.7 pound per second of steam at a terminal temperature of about 1130 degrees Celsius.

37. The process for producing electrical power of claim 36 wherein in the first combustion step 2.5 pounds per second methane is combusted with 251.7 pounds per second compressed air in the presence of 6.2 pounds per second of atomized water producing the first combustion stream to attain an auto ignition temperature of about 710 degrees Celsius..

38. The process for producing electrical power of claim 37 wherein in the second combustion step 2.5 pounds per second of methane is combusted with the first combustion stream in the presence of 31 pounds per second of atomized water producing the second combustion stream.

39. The process for producing electrical power of claim 38 wherein in the third combustion step 2.5 pounds per second of methane is combusted with the second combustion stream in the presence of 29.4 pounds per second of atomized water producing the third combustion stream.

40. The process for producing electrical power of claim 39 wherein in the fourth combustion step 1.5 pounds per second of methane is combusted with the third combustion stream producing the fourth combustion stream.

41. The process for producing electrical power of claim 40 wherein in the fifth combustion step 4.9 pounds per second of methane is combusted with the fourth combustion stream producing the fifth combustion stream having a terminal temperature of about 1130 degrees Celsius.

42. The process for producing electrical power of claim 41 wherein the fifth combustion stream is fed to the gas turbine generating 133.3 megawatts of electrical power and the gas turbine exhaust stream has a temperature of about 747 degrees Celsius.

43. The process for producing electrical power of claim 41 wherein the superheated steam is feed to the steam turbine generating 31 megawatts of power.

44. The process for producing electrical power of claim 41 wherein the heat exchanger condenses 83.7 pounds per second of water.

45. The process for producing electrical power of claim 44 wherein 66.6 pounds per second of water is recycled to the plurality of combustion steps and 17.1 pounds per second of water is transferred to a storage container.

46. The process for producing electrical power of claim 8 wherein gas vented from the heat exchanger comprises 195.7 pounds per second of nitrogen, 37.9 pounds per second of carbon dioxide, and 14.1 pounds per second of water.
